(19) United States
(12) Patent Application Publication
(10) Pub. No.: US 2016/0292396 A1
(43) Pub. Date: Oct. 6, 2016

(54) SYSTEM AND METHOD FOR AUTHENTICATING DIGITAL CONTENT

(71) Applicant: Iperial, Inc., Palo Alto, CA (US)

(72) Inventor: Stefan Akerwall, Campbell, CA (US)

(73) Assignee: Iperial, Inc., Palo Alto, CA (US)

(21) Appl. No.: 15/084,337

(22) Filed: Mar. 29, 2016

Related U.S. Application Data
(60) Provisional application No. 62/140,343, filed on Mar. 30, 2015.

(51) Int. Cl. G06F 21/10

(52) U.S. Cl. CPC G06F 21/10

(57) ABSTRACT

Various embodiments of the present invention relate generally to authenticating copies of digital information and support systems and methods for providing this authentication. For example, a system is described that uses the content, timestamp of registration, and user-identifying information of a particular digital content to generate a registration that can be subsequently used to authenticate the content. In certain embodiments, this registration is published to further enhance the strength of authentication and protect from improper changes. For example, a registration may be integrated within a public block chain according to various procedures to authenticate various parameters including time/date of registration, sequence position, content and other parameters known to one of skill in the art.

### CROSS-REFERENCE TO RELATED APPLICATIONS

This application claims the benefit of co-owned Provisional Application No. 62/140,343, entitled, “System and Method for Authenticating Digital Content by Distributing Unique Content Signatures,” and filed Mar. 30, 2015, which application is hereby incorporated herein by reference in its entirety.

### BACKGROUND

One skilled in the art will understand that copies of digital information may be exactly identical to each other and there is often no measurable quality degradation or other differences between these copies. Because of this issue, it may be impossible to know which digital information copy, such as a file in a set of copied files, is the original and which are copies of the original. Metadata such as date and time stamps commonly used for identifying files, emails and other types of digital information can easily be altered, and is not well suited to be used as evidence of an original copy.

Establishing who created a certain piece of content is often difficult, largely because of the problems associated with proving when the content was initially created. If, for example, a first person sends a copy of a computer file to a second person using prior art technologies, the second person can easily backdate the creation date of his/her copy and claim that he/she created the original file.

What is needed is a system and method that overcomes the foregoing problems existing in the art related to identifying an original or earlier copy of digital information or content and to show who first claimed to have access to that digital information.

### BRIEF SUMMARY OF THE INVENTION

The following is intended to be a brief summary of the invention and is not intended to limit the scope of the invention. Various embodiments of the present invention relate generally to authenticating copies of digital content and support systems and methods for providing this authentication. For example, a system is described that uses the content, timestamp of registration, and user-identifying information of a particular digital content to generate a registration that can be subsequently used to authenticate the content. In certain embodiments, this registration is published to further enhance the strength of authentication and protect from improper changes. For example, a registration may be integrated within a public block chain according to various procedures to authenticate various parameters including time/date of registration, sequence position, content and other parameters known to one of skill in the art.

In certain embodiments, the system and method identify when content was registered and which user-identifying information was used when the registration was created. The terms digital “information” and “content” are used interchangeably. Additionally, the terms “authenticate” and “validate” are also used interchangeably.

Various embodiments of the present invention make these facts immutable by publicly disclosing them in a way that makes it difficult to change without detection. Certain embodiments of the present invention also describe a system and method for searching for registered content to find out if a particular piece of content is registered, and if so when it was registered and which signature was used, and optionally for notifying the original registrant if someone else tries to register or authenticate the same information later on.

Further embodiments of the present invention also describe a system and method for stringing together more than one content registration, thereby creating an unbreakable chain of registrations where each registration has its own timestamp or other sequence identifier and points back to its own nearest ancestor. In various embodiments, this chain of registration provides identification of a particular order and/or particular time for each of the corresponding content within the chain. As used herein, the terms “ancestor” and “descendant” describes, for example, the relation between separate messages in an email discussion, or between versions of a file that are re-saved after changes have been made to it. Descendants are any chained items registered later than their ancestors, and vice versa. Also, as used herein, the term “chained” is used to describe registered items that are logically bound together because they are related. For example, a computer file that is saved multiple times with changes made between saves can be registered as a chain of registrations because the registrations all relate to different versions or generations of the same computer file. It is important to note that “chained” does not necessarily require that two chained contents/registrations share the same content; rather, that the contents have some type of relationship such as a content relationship, technical relationship, user relationship, temporal relationship or any other type of relationship known to one of skill in the art.

Various embodiments of the present invention can be used for registering all kinds of digital information, including all digital representations of non-digital information (for example, but not limited to, images of blueprints, or scanned copies of receipts).

In accordance with certain embodiments, the information that is registered can either be the actual content, or some unique representation of that content. One example of such a representation would be a cryptographic hash, which results from an algorithm that generates a string of bits that are unique for each set of input data. If a representation of the content is to be used instead of the content itself, the representation may be created using a deterministic routine such as an algorithm that produces the same output each time it is executed on the same input and configured such that the risk for collisions is negligible. A collision results when two different input values into a hashing function generate the same output value.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 shows an example of the logic flow of a check for an existing registration and subsequent optional new content registration in accordance with various embodiments of the invention.

FIG. 2 shows an example of the logic flow of the publishing of compiled lists of all registrations created during a period of time, and the subsequent publishing of the compilation and its corresponding cryptographic hash digest in accordance with various embodiments of the invention.

FIG. 3 shows an example of how registrations can be logically connected to form a chain in accordance with various embodiments of the invention.

FIG. 4 shows an example of how any changes to registrations that are logically connected can be detected in accordance with various embodiments of the invention

FIG. 5 shows first authentication system in accordance with various embodiments of the invention.

FIG. 6 shows a second exemplary authentication system in accordance with various embodiments of the invention.

FIG. 7 depicts a block diagram of an example of a computing system according to embodiments of the present invention.

### DETAILED DESCRIPTION OF THE INVENTION

The following description is presented to enable a person of ordinary skill in the art to make and use the invention, and is provided in the context of a particular application and its requirements. The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. The present invention may be operated, by way of example, as a computer program installed upon a computer or in some embedded system, via a website or other technical system.

In the following description, for purpose of explanation, specific details are set forth in order to provide an understanding of the invention. It will be apparent, however, to one skilled in the art that the invention may be practiced without these details. One skilled in the art will recognize that embodiments of the present invention, some of which are described below, may be incorporated into a number of different electrical components, circuits, devices and systems. The embodiments of the present invention may function in various different types of environments wherein the authentication of digital content may be relevant. Structures and devices shown below in block diagram are illustrative of exemplary embodiments of the invention and are meant to avoid obscuring the invention. Furthermore, connections between components within the figures are not intended to be limited to direct connections. Rather, connections between these components may be modified, re-formatted or otherwise changed by intermediary components.

Reference in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

According to various embodiments, a system uses at least two pieces of information as inputs into a one-way function, such as a hashing function, to generate an output that can be used to authenticate content such as data, a document, a file or any other information known to one of skill in the art. Various characteristics of the content can be authenticated using the system including a time of registration, a user associated with the content, the actual content itself, or other characteristics known to one of skill in the art. This output functions as a registration which can be publicly stored or otherwise processed, and subsequently used to authenticate corresponding content. One skilled in the art will recognize that various forms of input and combinations thereof may be used to generate a unique identifier that can authenticate information.

The first input is a portion of or the entire content that will be registered within the system. This content can be the actual digital information that the registrant wants to register, or it can be a unique representation (for example a cryptographic hash digest) of that information. If a hash digest is used as the first input, the owner of the content can maintain proprietary control of that content because the hash digest is generated by the owner. Accordingly, certain embodiments don't require the actual content as a first input, but allow other inputs derived from or related to the actual content to be used such that the input can be shown to have a relationship back to the content. In the instance of a hash digest being used, a corresponding hash function is deterministic, and thus will generate the same hash every time it's executed with the same content as input. Because of the deterministic nature of hashes, they can be used to prove that a certain input, the content, was used to generate a certain hash.

Other embodiments may add additional information to the content hash, for example by concatenating the content with the additional metadata. This method makes it possible to hide the actual content hash in such a way, that to authenticate the content one would have to access not only the content itself or the hash thereof, but also to the additional metadata. Possible implementations of this method include adding a secret “password” to the content registration, so that anyone who wants to authenticate the existence of a registration would have to have access to both the content and the password that was used as metadata when the registration was created. This might be valuable, for example, in a situation where a user wants to destroy information at some point. If the password is destroyed it will no longer be possible to authenticate the registration, and without recovering the password it is impossible for anyone to prove that a certain document was ever registered. These passwords do not have to be stored within the system, and may be entirely up to the user to safeguard.

The second input into the system is a user-identifying text or other series of bits that will be published. This user-identifying information can be any string of characters or bits and may, in certain instances, include information that makes it useful in identifying the registrant. Embodiments of the present invention may use a variety of different types of information related to a user. For example, it may be left up to the registrant to provide information that fits the purpose of being user-identifying. The user- identifying information can be a clear-text string or any other series of bits, and from that follows that it also can be a cryptographic hash digest of a text-string or series of bits. If the user-identifying information used is indeed itself a digest, a copy of the original user identifying information may be kept for authentication purposes in a future dispute. One skilled in the art will recognize that copies of the clear-text user identifying information can be stored within a system or outside of it. Since the user-identifying information can be any series of bits, it follows that it can also be a block of information that actually authenticates the identity of the registrant using, for example, stored secret keys for digital signatures.

Using a digest as the user-identifying information provides an extra layer of anonymity, since no readable information is divulged in a digest. According to one embodiment, if both a content digest and a user identifying information digest are used, the only readable information that will be made public is the sequence identifier of the registration, as described below.

Additional information may be used as further inputs into the system to generate a registration. For example, a sequence identifier such as a text string containing the current date and time when the registration was submitted may be used. The sequence identifier can be a representation of a date and time such as the current date and time in UTC, the Coordinated Universal Time zone commonly used across the world to make sure timestamps can be compared, or any other information that can be used to establish the order of registrations. One skilled in the art will recognize that any type of time identifier may be used that provides date, time, sequence or any other information about when or where content was registered.

In various embodiments of the invention, the system receives a combination of these inputs described above and generates a registration digest. In one embodiment, the registration digest is an output string generated by concatenating the content, sequence identifier, and user-identifying text and calculating a cryptographic hash digest from this concatenated string. One skilled in the art will recognize that various hash functions may be used to generate the registration digest. Further, one skilled in the art will recognize that the order of inputs into the system may vary across embodiments. In another embodiment, one skilled in the art will recognize that the number of other fields used to create the registration digest above might vary, so that additional metadata might be encoded into the output.

The content digest and the registration digest may be stored in a database and, according to one embodiment of the present invention, both these pieces of information are published together with both the sequence identifier and the user-identifying information that was used.

In various embodiments of the invention, the registration digest may be re-generated using the content identifier, the sequence identifier and the user-identifying information, and as such, the publicly disclosed information can be used for authenticating the correctness of the registration digest.

In certain examples, a one-way function such as a cryptographic hash is used to generate the registration digest from the specific content digest, the specific sequence identifier and the specific user-identifying information and therefore a unique relationship would exist that would allow strong authentication. One such example is explained in more detail below.

A first step comprises the calculation of a content identifier associated with a particular content that is to be authenticated. In this example, the content identifier is generated by re-calculating a digest of the content which was originally registered. In some examples, the re-calculated digest should match the previously stored content identifier piece. If this content identifier does match a previously stored content identifier, then the content that was registered is identical with the content that is being authenticated.

A second step comprises the creation of a concatenated string that at least partially includes, and or at least is partially generated from, the content identifier described above, the sequence identifier (published or private) and the user-identifying information (published or private). A digest is calculated from the concatenated string. If the calculated digest matches the registration digest (published or private), then the specific content identifier was registered with the specific sequence identifier and with the specific user-identifying information.

The exemplary process outlined above shows that a specific pair of sequence identifier and user- identifying information was used when a specific piece of content was registered. One skilled in the art will recognize that a variety of different content-related identifiers may be used to generate the registration digest that will subsequently authenticate the content.

This particular method may be supplemented to further enhance the content authentication process. For example, an individual may be able to “back stamp” a registration to make it seem like it was done earlier than it actually was by inserting a registration with a fake sequence identifier that would indicate an earlier date via illicit access to the databases in which the registrations are stored. To reduce this risk, embodiments of the present invention also publicly discloses lists of all registrations done during periods of time. These lists of registrations are herein called compilations. For example, the embodiments can publish a compilation of registration digests that were generated over a particular time period. This publication can occur within a pre-defined schedule or be generated when a certain number of registration digests have been created, or randomly. In one example, a compilation of registrations created during a particular hour are published at the end of this hour and sorted in such a way that each registration digest is sequenced in a particular position in that published list.

In various embodiments, this compilation and information about the time period and the cryptographic hash digest of the compilation itself, may also be distributed, such as by being published on the Internet. This publication would establish evidential support of the registration as well as allow others to download, store and/or re-publish.

Embodiments of the present invention may also comprise software and/or hardware components that automatically download copies of the compilations and/or cryptographic hash digests. In certain instances, software on the registrant's computer may support such a process. As a result, this information is distributed to multiple public domains, which further strengthens the effect of publishing the information by creating more copies that would have to be modified in order for someone to be able to modify a registration in an undetectable way. Furthermore, the hash digest of the compilation and/or the compilations themselves can be persisted into unmodifiable, publicly accessible registers such as the Bitcoin Blockchain, where both its existence and date of insertion can be authenticated.

The compilations may be sorted in such a way that each registration has a verifiable position in the list, and since the compilations are immutable after publication (as a consequence of them having been published or otherwise shared with others), any changes to them would be detectable. If someone were to tamper with a registration so that it received an incorrect sequence identifier, this registration would not be found at the expected position in the compilation for that period, and illicitly adding them to the compilation at the correct position would change the calculated cryptographic hash digest of the compilation. As a result, the detectability of tampering with these compilations increases dramatically.

In theory, for tampering to be undetectable, an attacker would have to seek out and change all published copies of the compilations and update them all. In so doing, the attacker would have to update any references to the original compilations and their cryptographic hash digests found on web pages, search engines and other places on the Internet and elsewhere. Doing so would require getting illicit access to each place where a copy of a compilation or a cryptographic hash digest thereof is stored, including any search engines that has indexed the documents, any social media or other websites where the information is published and any publicly available registers like the Bitcoin Blockchain. The fact that the compilations can be downloaded by anyone means that an attacker can never know how many copies exist and where these copies are stored, and thus there is no way to know if all copies have been changed. Thus, the public disclosure works as tamper evidence.

Because published data should be immutable, a publicly disclosed registration should preferably not be deleted or modified in such a way that it can no longer be authenticated. According to one embodiment of the present invention, a user is limited in his/her ability to control a published registration. One skilled in the art will recognize that various procedures may be established to protect the ability to change a registration but still provide some operability to the user. For example, a user may be able to relinquish his/her registration of a particular piece of content, and doing so should not remove the registration from the databases but merely flag it as released and possibly hide the user-identifying information. This feature is intended to be used to facilitate, for example, the transfer of ownership of content. If the original registrant wants to transfer ownership, he or she can relinquish the registration, whereupon it can be re-registered by the new owner. To make sure a third party registrant could not register the same content in the time period between the relinquish and the re-registration, both of these actions can be performed as a single transaction that makes sure that either both relinquish and the re-registration occurs, or neither occurs.

As previously described, embodiments of the present invention can register all kinds of digital information and may include any string of digital data regardless of length. It can, for example, be used to register each image in a user's digital photo library, each email message that someone sends or receives, each file that is created or saved in a folder on a hard drive of a computer, or in a cloud based storage solution or any posting made on blogs, social media services, comment section, web pages or any other system that accepts user input or any other content known to one of skill in the art. It can also be used to register digital representations of non-digital objects, for example scanned or photographed copies of information on paper, recorded sound clips or video clips depicting physical, three dimensional objects, and to register transactions between two or more parties in such a way that these transactions get a third-party sequence identifier that can't be changed by anyone.

A registration of a particular content will not in itself stop anyone from creating copies of the registered work; rather, it will provides evidence that someone using a specific signature indeed registered a particular piece of content as early as the date and time indicated by the sequence identifier. If the user-identifying information is selected in such a way that it actually identifies the registrant in a reasonable way, that evidence will help the original registrant to prove his or her case, either in a court of law or during other negotiations. In another embodiment, built-in registration verification routines may be included within a computer operating system. These verification routines could be used to stop a user from saving a file whose content is already registered by someone else. One skilled in the art will recognize that various embodiments of the invention may be included within a computer operating system to automate or enhance the registration process.

In one embodiment of the present invention, a chain-of-events record can be created to bind, for example, two different versions of the same computer file together to show that the new content is a later version of the old content. This record could be created by calculating a new digest of the new content and then registering that digest in a database using the digest of the previous version as the user-identifying information. Embedding the previous digest into the user- identifying information of the new registration effectively creates a chain where each link points back to its nearest ancestor, because only the nearest ancestor would have that specific digest embedded into its registration identifier. One skilled in the art will recognize that various forms of chaining registration identifiers are supported by embodiments of the invention.

This chaining results in the difficulty, if not impossibility, of another individual to either remove links or add any new links in between already existing links without breaking the chain in a detectable way. If someone tries to insert a false registration by connecting a new chain-of-events registration to any other location within the chain (i.e., a location that is not the closest to the most recent identifier), then the false registration will receive a later sequence identifier than the correct latest descendant copy resulting in a detectable inconsistency and evidence of the fraudulent activity.

The chain-of-events records can also, in other embodiments of the present invention, be used for showing that messages in an email or other digital discussion threads were transmitted in a particular order. Registration of these records define a particular sequence based on the chained identifiers. This registration chaining may be achieved by registering each message in a conversation as they are sent or received, chaining each new message to the previous one and thus creating a chain that grows with one link for each message transaction.

By way of example, to find out if a particular piece of content is registered, a user of the present invention could either provide a system with the content or the hash digest of the content depending on what was originally registered. Embodiments of the present invention may check its databases to see if that particular content or digest is found, and if so return the publicly accessible information about the registration.

Other embodiments of the present invention may use non-bitwise fingerprints of the information that is registered. These fingerprints are condensed digital summaries of the registered information, and allow the identification of other registered content having at least some portion of similarity but not necessarily identical to the content being checked. This feature makes it possible to find, for example, images that have been re-touched, texts that are nearly the same or a document that has the same content but has been saved in a different file format.

Embodiments of the present invention may use analytic tools that determine how much one set of data differs from another set of data. For example, one skilled in the art will recognize that delta encoding or data differencing routines may be applied to registration identifiers to measure the similarity between different identifiers. Using well-known techniques like these, a user may find the closely matching registered piece of content(s) regardless of how different the sets are and may be able to find a nearest match because this nearest match will be among the items with the least differences from the one that is being checked. One skilled in the art will recognize that embodiments of the present invention may be configured with both binary, general-purpose data differencing and with content type specific differencing routines. For example, the routines used to find the difference between two images might not be the same routines used for calculating the difference between two texts.

The ability to integrate different analytic routines to extract information from registration identifiers is a beneficial aspect of embodiments of the present invention. These integrated routines allow matching of the perceptual characteristics of different pieces of content and not just the binary representations of them. In short, if one piece of content looks the same to a human eye it may be presented as a close match even if the byte sequence that was originally registered is quite different. One example would be the same image stored in two different file formats like JPEG and TIFF. The byte sequence of these two files would have almost no matches and thus a very high binary data difference, but the two images would still be almost indistinguishable to a human eye, and thus have a very low perceptual difference.

In other embodiments of the present invention, a system may also store and use metadata related to the content that is registered. This metadata can be a combination of private (i.e., the metadata is only available and visible to the person or organization that registered the content) and/or public (i.e., the metadata is viewable by anyone looking at the registration). Private metadata can, for example, be used by the registrant to search for, sort and select registered content, and public metadata can be used to describe the content, with or without also providing access to the registered content itself. In addition to private and public metadata, a system may also add different kinds of system metadata, for example in the form of links to nearest ancestor/descendant in the case of chain-of-events registrations, or non-bitwise fingerprints. One skilled in the art will recognize that various types of metadata may be used within systems in accordance to embodiments of the invention.

According to a further embodiment, a system can use accounts to connect registered content to a registrant. These accounts can be either personal (one account has one user) or organizational (one account can have multiple users). For organizational accounts, one or more account administrators may manage the account users. The identity of the persons using these accounts can be verified or unverified.

As an additional optional feature, the system can store the actual content for later retrieval. Storage could be used to make sure that an exact copy of the content that was registered is retained, so that the original content isn't lost. This storage of content may be automated within the system such as having software routines present on computers that automatically upload content into storage and generate any appropriate registrations. These software routines may operate in various operating systems and be programmed to function according to a diverse set of parameters including user-specific parameters as well as organizational-specific parameters. The automated process may include the storage of content based on save requests, period of time, or any other parameter known to one of skill in the art.

The stored content can be made retrievable either by the registrant, his or her organization, or the general public. The accessibility scope is set, for example, by the registrant, or, in the case of organizational accounts, by the account administrator and/or the registrant. Registered content can also be attached to a license that regulates how the content may and may not be used. In cases where content is made publicly available, this means that a system can be used as a marketplace for content where buyers can search for and license publicly available content.

Embodiments of the present invention may be implemented as one publicly available system where registrations of content (or content digests) are stored on a public server together with metadata about the content (e.g., file names, descriptions and other information that helps the registrant manage the library of registered content and to find previously registered items). In this case all this data may be stored centrally in a system that is accessible by each user of the present invention.

Users with high demands on data confidentiality, the embodiments of the present invention can instead be implemented as a multi-tier solution, where a local server is placed inside the internal network of a user. The local server functions as a conduit between the end users and the public server so that the end user would have the local server as his only point of contact, and the local server would be the only part of the system that communicates with the public server. The local server would store all metadata about registered content so that it would not have to be transferred to or stored on the public server. The only information that would have to be sent from the local server to the public server when a registration is being submitted is, in these embodiments, the digests of the content and the digests of the user-identifying information. Neither of these digests contain any readable information about the content or the user-identifying information itself and all information that could be sensitive remains on the local server, protected by the user's own data security systems and stored in databases hosted by the user or by their data storage partners.

The inclusion of storage, automated or otherwise, allows user sensitive content to be stored locally with a user while registrations or digests are made public for purposes of authentication but don't provide any actual content of what is being authenticated. For example, the system may receive a content digest and user-identifying information from a local server so that it can generate a registration identifier, but the actual content itself would remain in the domain of the user. In another embodiment, the local server might not even transmit any information about each registration it processes, but instead only transmit the hash of a compilation of hashes during intervals, in the same way as the public server publishes its compilations and hashes thereof.

Since the local server resides inside a user-trusted computing environment and does not send any sensitive information to the outside of that environment, it can also be used to index and store any content that is registered. The index can later be used for searching for registered content. As previously discussed, this functionality may be combined with software routines that are installed on an end- user's computer that automatically sends each changed file or document to the local server for storage, indexing and content registration.

According to other embodiments of the invention, a system may also include timestamp functionality. A registered timestamp is, in its simplest form, just the registration identification of a piece of content that uniquely identifies the transaction for which it is created, and the date and time at which the registration occurred. The timestamps can be used to show that, for example, all parties in a contract agree on a common date and time.

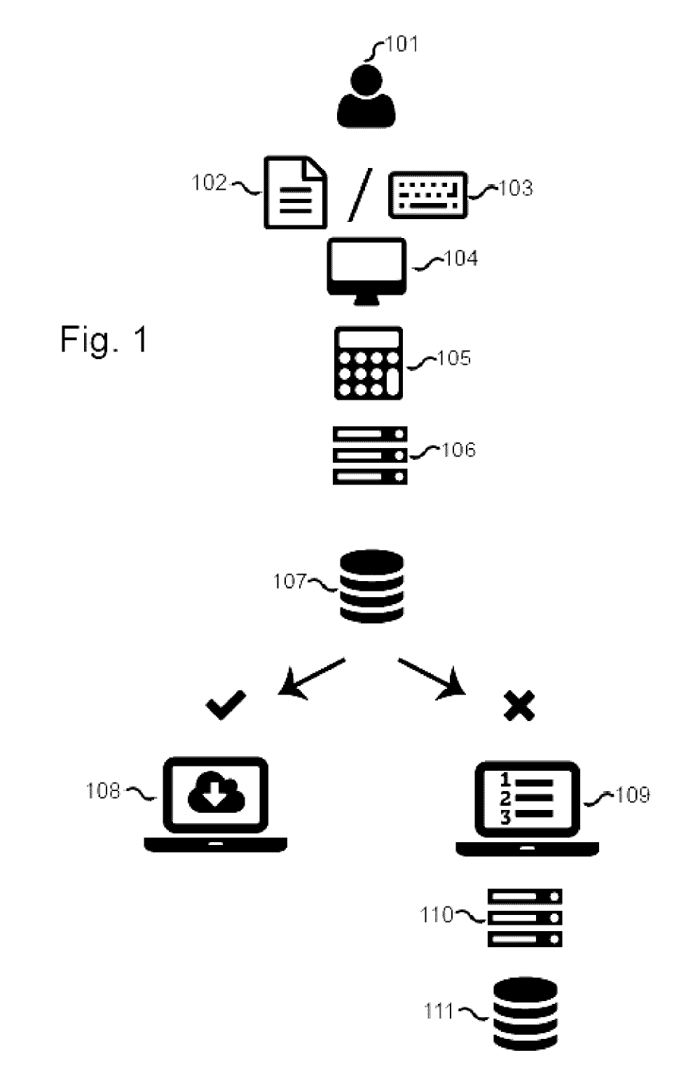

Embodiments of the present invention will now be described in reference to FIGS. 1-7 with an illustrative example of how to first check if a piece of content is already registered. It will also be described with an illustrative example of how the publication of compilations are created and subsequently published to make the information immutable. Embodiments of the present invention will be described with an illustrative example of how any changes to registrations that are logically connected can be detected, and how that detection works as tamper evidence. Additional figures will also describe various authentication systems in accordance with embodiments of the invention.

FIG. 1 describes an authentication system for content according to various embodiments of the invention. A user 101 (a human being or an automated process) inputs a piece of content, either in the form of a file 102 or as text or any other data stream 103 into a computing device 104 within the system. This input may occur on various interfaces of the computing device 104 known to one of skill in the art. The computing device 104 calculates a cryptographic hash digest of the file 102 or other data stream 103, and sends the calculated digest 105 to a server 106 via another interface and over some communications channel. This communication channel may be public or private, and may be networked or point-to-point. In certain embodiments, the information sent between the computing device 104 and the server 106 is the calculated hash digest 105. The system uses this digest 105 to check for a pre-existing registration of the hash digest 105. These pre-existing registrations are generated and stored registration digests in a manner similar to those described above. One skilled in the art will recognize that other information or content may be transmitted between the computing device 104 and the server 106.

The server 106 performs a lookup in a database 107 that contains all previously created registrations (i.e., stored registration digests or modifications of registration digests). In certain embodiments, the server 106 uses another interface to communicate with a look-up server. If the result of that lookup is that the hash digest 105 already exists, then the server 106 returns the public information about the previous registration 108. If the result of that lookup is that the hash digest 105 does not exist, the server 106 instead returns information about the uniqueness of the digest 105. In either case, the computing device 104 presents the user 101 with an option to register 109 the calculated hash digest 105 or the computing device 104 initiates an automated response such as a registration routine.

In certain embodiments, the user 101 may provide additional informational parameters to be used within the hashing process in a similar manner to those described above. Additionally, the system may automatically include other parameters in the hashing process. If the user 101 wants to register the new hash digest 105, some extra information such as which user-identifying information to use is collected from the user or automated process 101. For example, a user 101 may fill in a form on the monitor of computing device 104, or in the case of an automated process by populating a data structure. Both the user-identifying information and the hash digest 105 are then sent to the server 110 via an interface. In certain embodiments, the server 110 then adds a sequence identifier, calculates the registration digest and stores the registration in the database 111 or 107. One skilled in the art will recognize that the database storing the registration digests may be located within a local network or on a public network. Additionally, the database may be distributed across a plurality of networks.

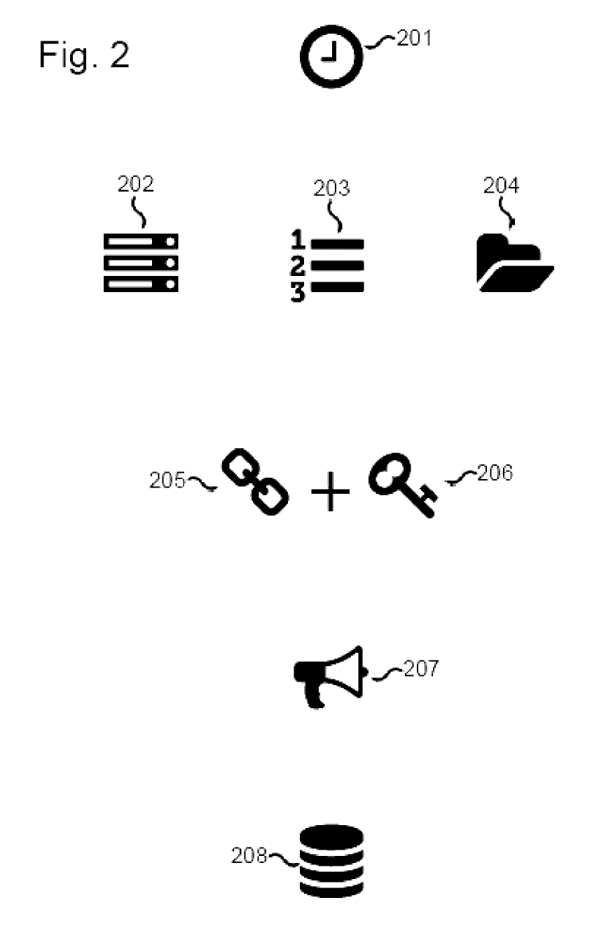

FIG. 2 illustrates processes, and corresponding structure, used in generating, storing and compiling registration identifiers according to various embodiments of the invention. A computer implemented routine is executed at intervals 201 (regular, event-based or random periods of time) on a computing device. The result of that execution is that a request is made to a server 202 to create a compilation of all new registrations 203 created during the previous interval. This compilation is then stored 204 in such a way that it can be made publicly available to anyone who wants to download it.

In some embodiments, a Uniform Resource Locator (URL) 205 that is publicly accessible is assigned to the compilation 203, and a cryptographic hash digest 206 of the compilation is created. Both these pieces of data may be published 207 by various methods (e.g., published on the website of the present invention, posted on social media websites and so on) known to one of skill in the art and are made available for indexing by web search engines 208. The publication of the compilation 203 results in multiple copies existing, and someone who wants to tamper with the registrations would have to search out and make changes to every published copy of the hash digest 206 or else the changes to the compilation 203 would be detectable.

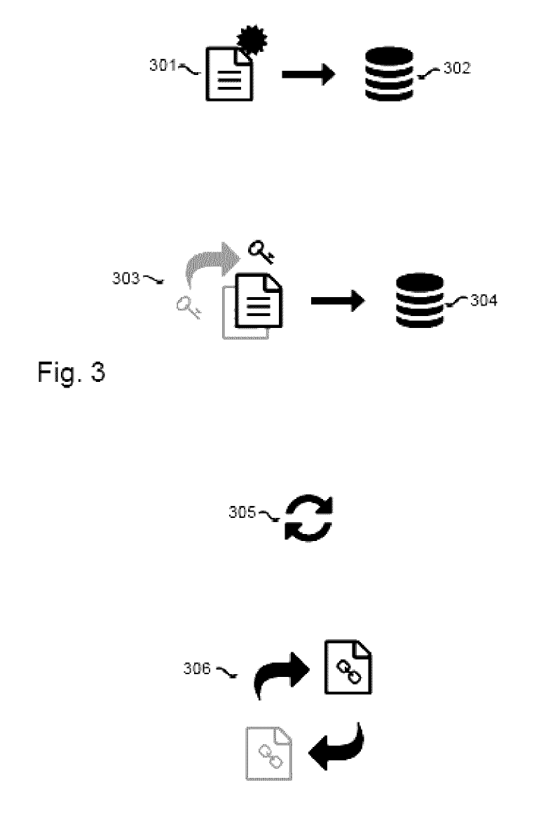

FIG. 3 illustrates a system and method for chaining registration identifiers in accordance with various embodiments of the invention. A new registration 301 is first inserted into the database 302 of the system. In certain embodiments, this registration 301 is created in the same way as any other new registration. To turn it into a link in a chain of logically connected registrations, a second registration 303 is inserted into the database 304 of the system. This second registration 303 embeds into its user-identifying information the registration identifier of the first registration 301. The database records of the first registration 301 and the second registration 303 are also updated so that the first registration 301 gets a link forward to the second registration 303, and that the second registration 303 gets a link back to the first registration 301.

To add more links to the chain of registrations, the process can be repeated any number of times and each new registration 303 embeds the registration identifier of the previous registration into its user-identifying information.

At any point in time, each link will be registered with a corresponding registration identifier of the previous link in its user-identifying information. As a result, a mathematical bond is formed between the registrations that can't be broken in an undetectable way.

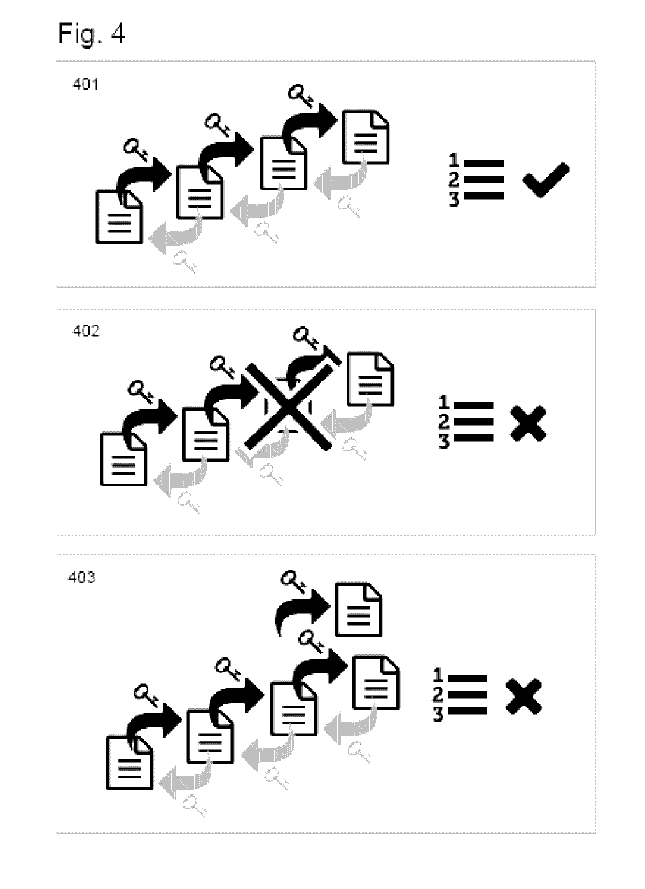

FIG. 4 illustrates a registration chaining system and method according to various embodiments of the invention. As shown, a valid chain of logically connected registrations 401 is maintained. Each link in the chain points to both its predecessor and to its successor (except the first and last link in the chain, because these items logically lack a predecessor and successor, respectively), and each successor embeds the registration identifier of its own nearest predecessor as its user-identifying information. A valid chain 401 can always be traversed from any link in the chain and all the way to both ends of the chain by re-calculating the hash digests of the registrations that make up the chain.

If a registration in the chain were to be either deleted or otherwise modified 402, the modified registration would no longer have a valid cryptographic hash digest, which would logically break the chain. An invalid chain 402 cannot be traversed by recalculating the hash digests. The only way to create a valid chain would be to re-create all successor links, and that would in turn be detectable because the information about the existing links is published in compilations, examples of which are described above.

If a new link is inserted into the chain as a successor to a registration that is not the last one in the chain 403, one registration would logically have two successors, only one of which is valid. To identify the valid registration, a validator would look at the sequence identifier of the two registrations that share a common predecessor. Since the sequence identifier always progresses in a known direction (the sequence identifier can, for example, be the current date and time) the oldest of the successors must be the correct one. Any attempt to modify the sequence identifier would furthermore be detectable because the information about existing sequence identifiers is published.

Exemplary Database Structure

In the example set forth below, one record contains all information needed for registering one piece of digital information. In various embodiments of the invention, these fields may be combined in various combinations and may exclude some of the fields in actual implementations.

Fields:

Content/Content Digest

Combined Digest

Sequence Identifier

User-identifying Information

Release Date (a field with null as its default value optionally used together with the Content/Content Digest to make sure a particular piece of content can only be registered by one registrant at a time. If a registrant relinquish a registration, the date and time at which this was done is set in this field, which frees the content digest for re-registration by some other registrant.

Chain-link to an optional previous version (nearest ancestor) of the content. Null value as default.

Chain-link to an optional next version (nearest descendant) of the content. Null value as default.

Other auxiliary fields (for example file names, user ID of registrant, data fingerprints and other metadata)

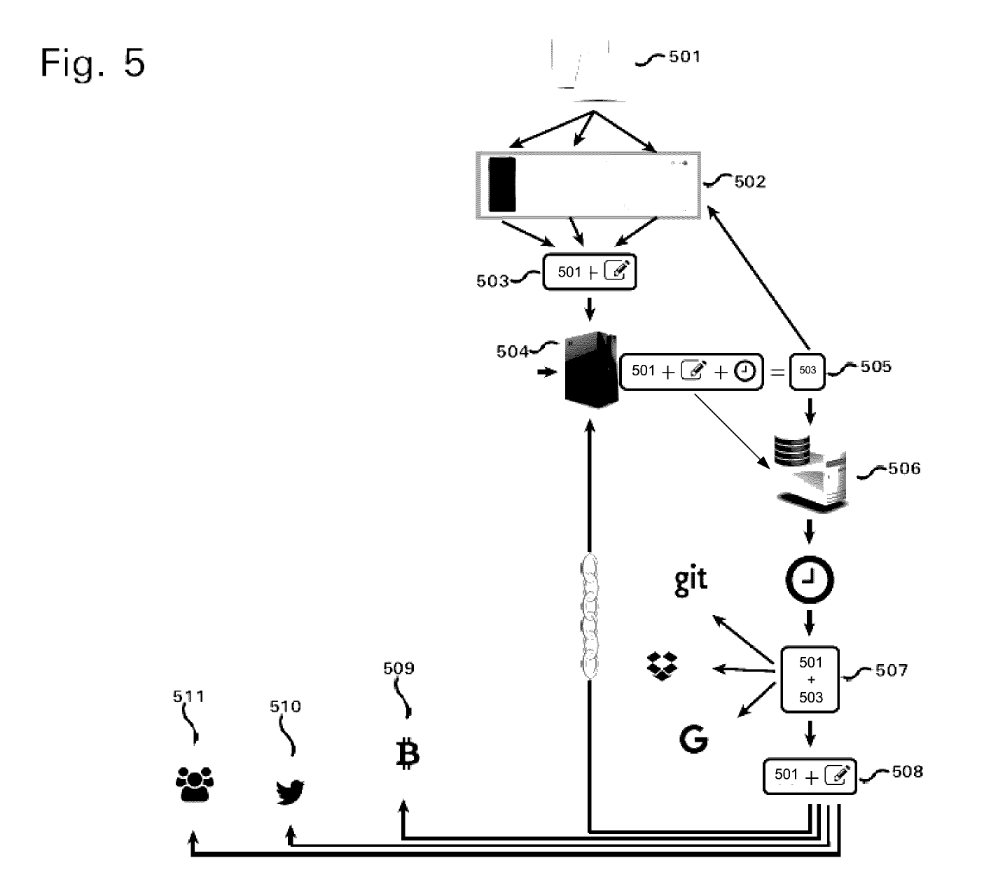

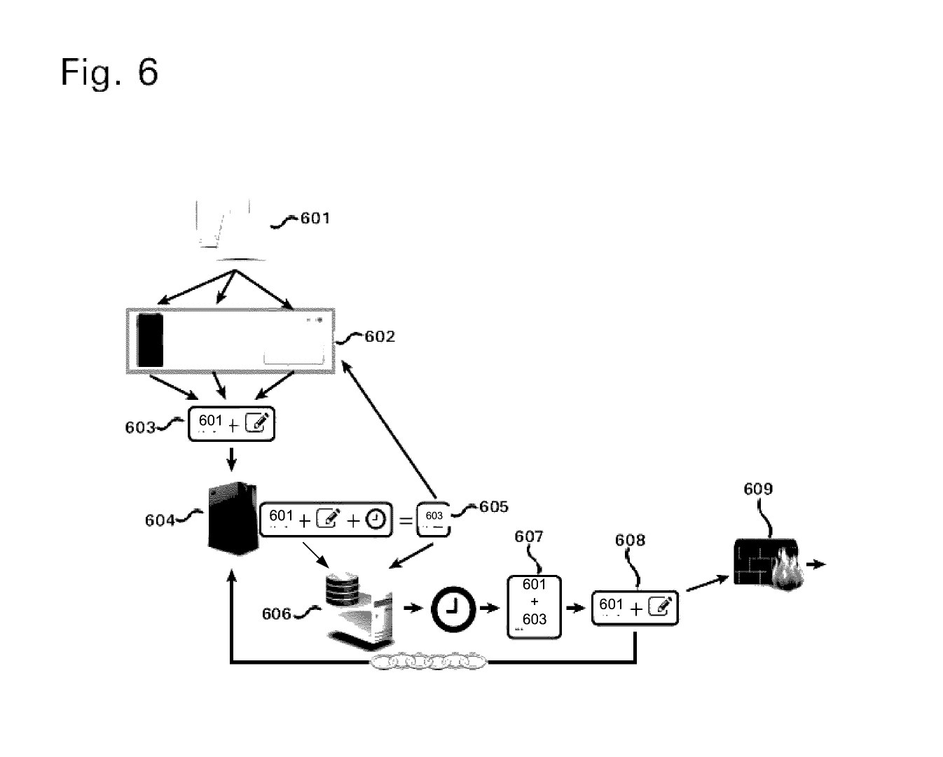

FIG. 5 illustrates a first authentication system in accordance with various embodiments of the invention. A piece of digital content 501 is created on or loaded into a computing device 502, or received from a proxy server such as the one described in FIG. 6. One skilled in the art will recognize that this content can be any string of bits, representing any kind of information, including digital depictions of analog, real-life objects. The computing device 502 calculates a content identifier, in this case in the form of a cryptographic hash. One skilled in the art will recognize that any type of identifier that uniquely identifies the content can be used.

A user-identifying series of bits, for example a text string containing the name of the registrant, is collected by the computing device 502, and is transmitted alongside the content identifier as data packet 503 to server 504. One skilled in the art will recognize that any kind of user-identifying series of bit can be used, including a null value which would enable the system to work without user identification.

The server 504 receives the transmission of the data packet 503, and combines the data with a sequence identifier to create a registration identifier 505. One skilled in the art will recognize that the sequence identifier can be any kind of data that establishes the order in which registration events happened, and that the current date and time is one example of such a sequence identifier.

The data packet 503 and the registration identifier 505 is stored by the server 506, so that the server 506 can, at intervals, create a compilation 507 of the pairs of data packets 503 and registration identifier 505 that is has received since the last compilation was created.

The compilation 507 is distributed to a number of platforms, external and internal, and a content identifier 508 is created for the compilation itself. The content identifier 508 is stored by the server 504 as belonging to the compilation for the next interval. One skilled in the art will recognize that this logically chains the created compilations to each other, further strengthening the interlocking authentication features of the system and making it harder to modify a stored registration in a way that can't be detected.

The content identifier 508 is also published to various other platforms such as social media websites, the Bitcoin Blockchain and so on. One skilled in the art will recognize that the ability to prove that the content identifier 508 exists also proves that the compilation 507 existed at the time indicated by the sequence identifier embedded in the content identifier 508, and thus that all data contained in all data packets 503 that make up the compilation 507 existed at the times indicated by their respective sequence identifiers.

FIG. 6 illustrates a second authentication system in accordance with various embodiments of the invention. A piece of digital content 601 is created on or loaded into a computing device 602. One skilled in the art will recognize that this content can be any string of bits, representing any kind of information, including digital depictions of analog, real-life objects. The computing device 602 calculates a content identifier, in this case in the form of a cryptographic hash. One skilled in the art will recognize that any type of identifier that uniquely identifies the content can be used.

A user-identifying series of bits, for example a text string containing the name of the registrant, is collected by the computing device 602, and is transmitted alongside the content identifier as data packet 603 to a proxy server 604 that resides inside the firewall. One skilled in the art will recognize that any kind of user-identifying series of bit can be used, including a null value which would enable the system to work without user identification.

The proxy server 604 receives the transmission of the data packet 603, and combines the data with a sequence identifier to create a registration identifier 605. One skilled in the art will recognize that the sequence identifier can be any kind of data that establishes the order in which registration events happened, and that the current date and time is one example of such a sequence identifier.

The data packet 603 and the registration identifier 605 is stored by the proxy server 606, so that the proxy server 606 can, at intervals, create a compilation 607 of the pairs of data packets 603 and registration identifier 605 that is has received since the last compilation was created.

A content identifier 608 is created for the compilation 607 itself, and is stored by the proxy server 604 as belonging to the compilation for the next interval. One skilled in the art will recognize that this logically chains the created compilations to each other, further strengthening the interlocking authentication features of the system and making it harder to modify a stored registration in a way that can't be detected.

The content identifier 608 is also transmitted through the firewall 609 to the public part of the system and example of which is described in FIG. 5.

In embodiments, a computing system may be configured to perform one or more of the methods, functions, and/or operations presented herein. Systems that implement at least one or more of the methods, functions, and/or operations described herein may comprise a time-related profile application operating on a computer system. The computer system may comprise one or more computers and one or more databases. In embodiments, the application may be part a network or may be a standalone device. In embodiments, the computer system may graphically depict profile information.

It shall be noted that the present invention may be implemented in any instruction-execution/computing device or system capable of processing data. The present invention may also be implemented into other computing devices and systems. Furthermore, aspects of the present invention may be implemented in a wide variety of ways including software, hardware, firmware, or combinations thereof. For example, the functions to practice various aspects of the present invention may be performed by components that are implemented in a wide variety of ways including discrete logic components, one or more application specific integrated circuits (ASICs), and/or program-controlled processors. It shall be noted that the manner in which these items are implemented is not critical to the present invention.

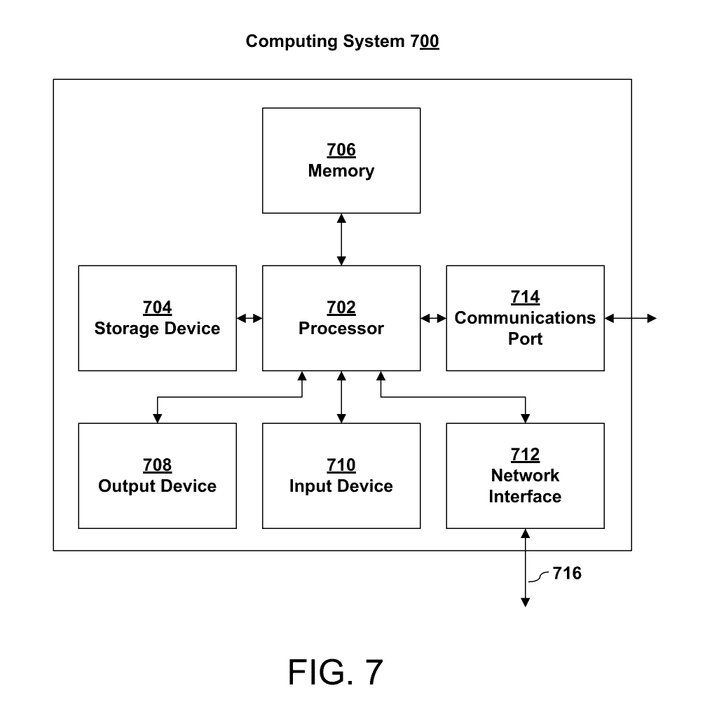

FIG. 7 depicts a functional block diagram of an embodiment of an instruction-execution/computing device 700 that may implement or embody embodiments of the present invention. As illustrated in FIG. 7, a processor 702 executes software instructions and interacts with other system components. In an embodiment, processor 702 may be a general purpose processor such as (by way of example and not limitation) an AMD processor, an INTEL processor, ARM-based processor, Nvidia processor, Asus processors or the processor may be an application specific processor or processors. A storage device 704, coupled to processor 702, provides long-term storage of data and software programs. Storage device 704 may be a hard disk drive and/or another device capable of storing data, such as a magnetic or optical media (e.g., diskettes, tapes, compact disk, DVD, and the like) drive or a solid-state memory device. Storage device 704 may hold programs, instructions, and/or data for use with processor 702. In an embodiment, programs or instructions stored on or loaded from storage device 704 may be loaded into memory 706 and executed by processor 702. In an embodiment, storage device 704 holds programs or instructions for implementing an operating system on processor 702. In one embodiment, possible operating systems include, but are not limited to, UNIX, AIX, LINUX, Microsoft Windows, and the Apple MAC OS, Apple iOS, Google Android, Symbian, Windows CE, OpenWrt, JunOS, Cisco IOS. In embodiments, the operating system executes on, and controls the operation of, the computing system 700.

An addressable memory 706, coupled to processor 702, may be used to store data and software instructions to be executed by processor 702. Memory 706 may be, for example, firmware, read only memory (ROM), flash memory, non-volatile random access memory (NVRAM), random access memory (RAM), or any combination thereof. In one embodiment, memory 706 stores a number of software objects, otherwise known as services, utilities, components, or modules. One skilled in the art will also recognize that storage 704 and memory 706 may be the same items and function in both capacities. In an embodiment, one or more of the methods, functions, or operations discussed herein may be implemented as modules stored in memory 704, 706 and executed by processor 702.

In an embodiment, computing system 700 provides the ability to communicate with other devices, other networks, or both. Computing system 700 may include one or more network interfaces or adapters 712, 714 to communicatively couple computing system 700 to other networks and devices. For example, computing system 700 may include a network interface 712, a communications port 714, or both, each of which are communicatively coupled to processor 702, and which may be used to couple computing system 700 to other computer systems, networks, and devices.

In an embodiment, computing system 700 may include one or more output devices 708, coupled to processor 702, to facilitate displaying graphics and text. Output devices 708 may include, but are not limited to, a display, LCD screen, CRT monitor, printer, touch screen, or other device for displaying information. Computing system 700 may also include a graphics adapter (not shown) to assist in displaying information or images on output device 708.

One or more input devices 710, coupled to processor 702, may be used to facilitate user input. Input device 710 may include, but are not limited to, a pointing device, such as a mouse, trackball, or touchpad, and may also include a keyboard or keypad to input data or instructions into computing system 700.

In an embodiment, computing system 700 may receive input, whether through communications port 714, network interface 712, stored data in memory 704/706, or through an input device 710, from a scanner, copier, facsimile machine, or other computing device.

In embodiments, computing system 700 may include one or more databases, some of which may store data used and/or generated by programs or applications. In embodiments, one or more databases may be located on one or more storage devices 704 resident within a computing system 700. In alternate embodiments, one or more databases may be remote (i.e., not local to the computing system 700) and share a network 716 connection with the computing system 700 via its network interface 714. In various embodiments, a database may be a relational database, such as an Oracle database, that is adapted to store, update, and retrieve data in response to SQL commands, or a NoSQL, Microsoft DocumentDB, Apache CouchDB, Couchbase, Google BigTable, Apache Cassandra or other data store, whether relational or not.

One skilled in the art will recognize no computing system or programming language is critical to the practice of the present invention. One skilled in the art will also recognize that a number of the elements described above may be physically and/or functionally separated into sub-modules or combined together.

It shall be noted that embodiments of the present invention may further relate to computer products with a computer-readable medium that have computer code thereon for performing various computer-implemented operations. The media and computer code may be those specially designed and constructed for the purposes of the present invention, or they may be of the kind known or available to those having skill in the relevant arts. Examples of computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a computer. Examples of program modules include libraries, programs, routines, objects, components, and data structures. In distributed computing environments, program modules may be physically located in settings that are local, remote, or both.

It will be appreciated to those skilled in the art that the preceding examples and embodiment are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention.

What is claimed is:

1. A method for generating and storing a registration digest within a compilation having a plurality of registration digests, the method comprising:
receiving a first data string at a first computing device, the first data string related to a piece of content to be registered;
receiving a second data string at the first computing device, the second data string comprising a user-identifying data associated with the content;
generating a registration digest associated with the content, the registration digest being generated using a one-way function with a first input receiving the first data string and with a second input receiving the second data string, the registration digest provides an authentication of at least one characteristic of the content; and
storing the registration digest within a storage device, the registration digest being stored in the compilation having a relational structure on a memory device, the relational structure supports the authentication of the at least one characteristic of the content.

2. The method of claim 1 further comprising the steps of:
receiving a third data string at the first computing device, the third data string comprising a sequence identifier data related to the content; and
wherein the registration digest is generated from the first data string, the second data string and the third data string using the one-way function.

3. The method of claim 2 wherein the sequence identifier data comprises a time stamp associated with the content.

4. The method of claim 1 wherein the one-way function is a cryptographic hash function.

5. The method of claim 1 wherein the first data string comprises the content.

6. The method of claim 1 wherein the first data string comprises a content digest generated from the content, the content digest being generated using a cryptographic hash function.

7. The method of claim 1 wherein the second data string relates to an individual associated with the content.

8. The method of claim 1 wherein the second data string relates to an organization associated with the content.

9. The method of claim 1 further comprising the step of publishing the content digest on a first server, the published content digest being located within a published compilation comprising a plurality of published registration digests.

10. The method of claim 1 wherein the content is authenticated by comparing the content digest to a later-generated content digest to determine whether the content digest and the later-generated content digest share a same plurality of inputs applied to the one-way function.

11. The method of claim 1 wherein the steps of receiving the first and second data strings are associated with automated routines operating on at least one client computer.

12. The method of claim 1 wherein the steps of receiving the first and second data strings are associated with manually-controlled operations on the computing device.

13. The method of claim 1 further comprising the step of automatically storing the content on a storage device, the stored content being associated with the registration digest.

14. A system for generating and storing a compilation of registration digests, the system comprising:
a first interface on a computing device, the first interface coupled to receive a first data string related to a content to be registered within the compilation;
a second interface on the computing device, the second interface coupled to receive a second data string comprising a user-identifying data of the content;
a one-way function operable on the computing device and coupled to the first and second interfaces, the one-way function generates a registration digest using the first and second data strings, the registration digest provides an authentication of at least one characteristic of the content; and
a memory device coupled to receive the registration digest, the memory device structured to store the registration digest in the compilation having a relational structure, the relational structure supports the authentication of the at least one characteristic of the content.

15. The system of claim 14 further comprising:
a third interface on the computing device, the third interface coupled to receive a third data string comprising a sequence identifier data related to the content; and
wherein the registration digest is generated from the first data string, the second data string and the third data string using the one-way function.

16. The system of claim 14 wherein the first and second interfaces are integrated into a single interface.

17. The system of claim 14 further comprising a publication server coupled to the computing device, the publication server publishes the compilation having the registration digest.

18. The system of claim 14 wherein the at least one characteristic comprises a timestamp associated with the registration digest.

19. The system of claim 14 wherein at least one characteristic comprises a sequential relationship of the registration digest within the compilation.

20. The system of claim 19 wherein the compilation is stored in a relational chaining structure.
